(19) United States
(12) Patent Application Publication
(10) Pub. No.: US 2008/0117050 A1
(43) Pub. Date: May 22, 2008

(54) WIRELESS RADIO FREQUENCY IDENTIFICATION SYSTEM AND METHOD FOR CONTROLLING THE ACTIVE RADIO FREQUENCY IDENTIFICATION TAG

(75) Inventors: Cheng-Hsuan Wu, Taipei City (TW); Jiunn-Tsair Chen, Hsinchu City (TW); Shu-Hsien Wang, Kaohsiung City (TW); Jian-Ren Chen, Jhudong Township (TW)

Correspondence Address: J C PATENTS, INC., 4 VENTURE, SUITE 250, IRVINE, CA, 92618, US

(73) Assignee: INDUSTRIAL TECHNOLOGY RESEARCH INSTITUTE, Hsinchu (TW)

(21) Appl. No.: 11/753,844

(22) Filed: May 25, 2007

Related U.S. Application Data
(60) Provisional application No. 60/866,858, filed on Nov. 22, 2006.

(30) Foreign Application Priority Data
Mar. 9, 2007 (TW) 96108238

(51) Int. Cl. G08B 13/14

(52) U.S. Cl. 340/572.1; 340/10.1

(57) ABSTRACT

A wireless radio frequency identification (RFID) system is provided. The wireless RFID system includes at least one passive RFID tag, at least one active RFID tag and at least one sink apparatus. The active RFID tag transmits a wireless query signal to detect whether the passive RFID tag and /or other active RFID tags are in its scanning range according to a transmission specification. Moreover, the active RFID tag collects the detecting result into an inventory data, converts itself to one passive RFID tag, and transmits the inventory data to other active RFID tags utilizing the same method. Then, an identification data in the passive RFID tag and /or the inventory data in the active RFID tag are read by the sink apparatus according to the above-mentioned transmission specification. Therefore, the wireless RFID only uses a signal transmission specification to route the data back to the sink apparatus.

### CROSS-REFERENCE TO RELATED APPLICATION

This application claims the priority benefit of U.S.A. provisional application Ser. No. 60/866,858, filed on Nov. 22, 2006 and Taiwan application serial no. 96108238, filed Mar. 9, 2007, all disclosures are incorporated herein by reference.

### BACKGROUND OF THE INVENTION

1. Field of the Invention

The present invention is related to a radio frequency identification (RFID) system, and more particularly to a radio frequency identification system supports only one transmission specification.

2. Description of Related Art

With the changes of global economic concepts and shopping habits, recently, there is a significant change occurred in marketing channels of retailing channels such as convenience stores, general merchandise stores and large-scale department stores. The main reason is that the marketing channel via previous multiple complex channels among each node of manufacturing, wholesaling, storing and retailing of large retail channels have been gradually changed to an simplified operating manner from manufacturing to each retail nodes via logistic centers.

Recently, a radio frequency identification system is adopted by most large retailing channels to effectively enhance the efficiency of logistics systems such as on goods controlling and quantity monitoring. Among researches and applications upon the radio frequency system, many researches focus on issues such as enhancing the reading performance between the identification tag and the reader, and reducing the cost. However, as for how the reader delivers the inventory data obtained thereby to a sink apparatus, there is still no specific operating mode and standard that can be followed. Generally, based on the manner how the reader and the sink apparatus transmit data, the RIFD system can be generally divided into wired construction and wireless construction. With respect to the wired RFID system, the reader can be connected with the sink apparatus via communication interfaces like RS-232, RS-485. There are many advantages provided with such transferring method such as mature technology, high speed, however, there is a fatal weakness existing in the wired RFID system, that is, being lacking of mobile capability. And for many RFID systems, this is not allowed.

Meanwhile, FIG. 1 illustrates a schematic diagram of a traditional radio frequency identification system. With reference to FIG. 1, a traditional radio frequency identification system 100 includes a plurality of passive RFID tags, a plurality of readers and a sink apparatus 110. For the convenience of description, only passive RFID tags 120 to 130 and a reader 140 are labeled herein. For delivering signals, the reader 140 uses a transmission specification of class-1 generation-2 set by an electronic product code (hereinafter called “EPC”) standard to perform reading the passive RFID tag, that is, the passive RFID tag can determine whether to be added into an inventory process based on a query signal sent by the reader 140. When the passive RFID tags 120 and 130 are detected within the scanning range of the reader 140 thereby, and an inventory data is collected according to the detecting result, the reader 140 can transmit the inventory data to the sink apparatus 110. It should be noted that at this time, the reader 140 performs transferring data based on another transmission specification, for example, a transmission specification set by zigbee or z-wave.

In other words, the reader in the traditional RFID system 110 is required to support both two transmission specifications in order to accomplish transferring data. However, such manner utilizing two transmission specifications to deliver signals causes the traditional RFID system 110 into many problems, which will be respectively discussed hereinafter.

Under the consideration of time, the traditional RFID system 110 has to support two transmission specifications, for example, those of class-1 generation-2 set by EPC standard and those set by zigbee so that thus it is required to spend extra time on repackaging the stacks regulated by class-1 generation-2 into those specified by zigbee.

Under the consideration of power, the traditional RFID system 110 has to consume extra energy on the converting of stacks.

Under the consideration of cost, each reader in the traditional RFID system 110 is required to have two set of hardware devices simultaneously for performing two different sets of transmission specifications respectively. Accordingly, the system cost will be increased.

Under the consideration of compatibility, so far, zigbee and z-wave are still competitors against each other, therefore, it can not be predicted which can be the final mainstream of transmission specification. Eventually, regardless whether transmission specification set by zigbee or z-wave is adopted, there is still a problem that one of them can not be applied in the future.

### SUMMARY OF THE INVENTION

A radio frequency identification system is provided in the present invention. With utilizing an active RFID supporting only one transmission specification, the present invention can accomplish a feature in which the identification data in a passive RFID tag and/or the inventory data in an active RFID tag can be detected and read, and then furthermore the disadvantages on hardware cost and power consumption of the RFID system can be reduced.

An embodiment of the present invention can provide an operating method for an active RFID tag, by which the active RFID tag supports only one transmission specification so that the RFID system applying the method can have an effect with high compatibility, low complexity, low cost and time saving.

Another embodiment of the present invention can provide a wireless RFID system, which includes at least one passive RFID tag, at least one active RFID tag and at least one sink apparatus. Among them, the above-mentioned active RFID tag transmits a wireless query signal to detect whether the passive RFID tag and/or other active RFID tags are within a scanning range thereof based on a transmission specification, and collects the detecting result into an inventory data. Then, the sink apparatus transmits another wireless query signal based on the above-mentioned transmission specification to detect whether a passive RFID tag and/or an active RFID tag are within the scanning range thereof to further read the identification data in the passive RFID tag and/or the inventory data in the active RFID tag.

Meanwhile, still another embodiment of the present invention can further provide another operating method for the active RFID tag, which includes transmitting a wireless query signal based on a transmission specification first, then detecting whether a passive RFID tag and/or other active RFID tags are within the scanning range of the active RFID tag to obtain a detecting result, and collecting an inventory data according to the detecting result.

In addition, the operating method detects whether there is an external wireless query signal based on the above-mentioned transmission specification and when the external wireless query signal is received, an inventory data is transmitted based on the above-mentioned transmission specification in response thereto. The present invention adopts an active RFID tag supporting only one transmission specification to accomplish the feature in which the identification data in the passive RFID tag and/or the inventory data in the active RFID data can be detected and read so that thus the RFID system applying the active RFID tag can have an effect with high compatibility, low complexity, low cost and time saving.

In order to make the aforementioned and other objects, features and advantages of the present invention more comprehensible, embodiments accompanied with figures are described in detail below.

### BRIEF DESCRIPTION OF THE DRAWINGS

FIG. 1 illustrates a schematic diagram of a traditional radio frequency identification system.

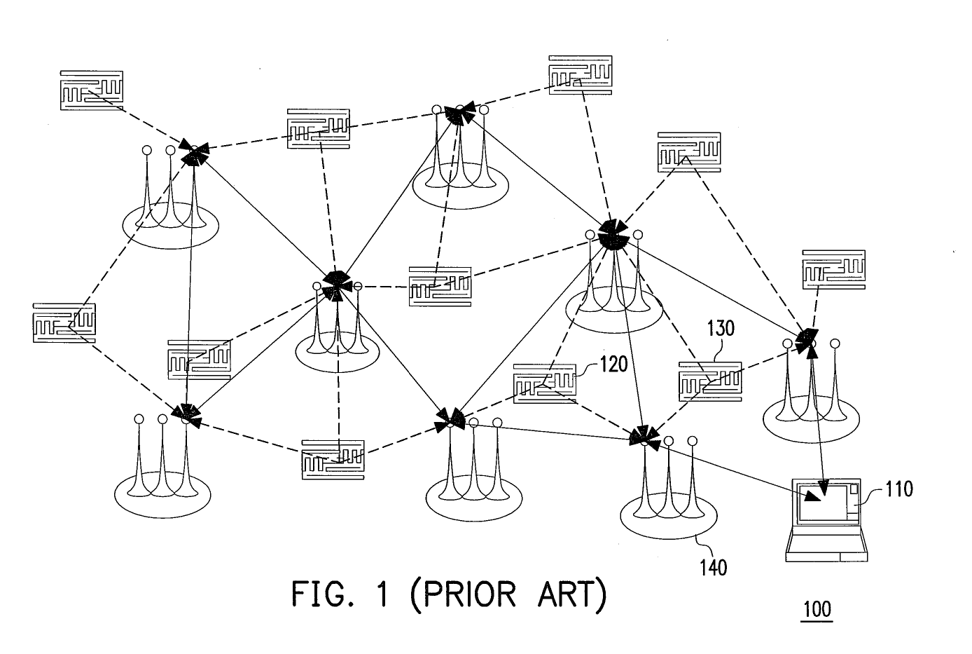

FIG. 2 illustrates a schematic diagram of a radio frequency identification system in accordance with one embodiment of the present invention.

FIG. 3 illustrates a schematic diagram for illustrating a construction schema of an ad-hoc network in the embodiment of FIG. 2.

FIG. 4 is a simulated chart in accordance with one embodiment of the present invention.

FIG. 5 is a schematic diagram for illustrating the simulated platform of the embodiment of FIG. 4.

FIG. 6 illustrates a table of simulation result for explaining one embodiment of the present invention.

FIG. 7 illustrates another table of simulation result for describing one embodiment of the present invention.

FIG. 8 illustrates a flow chart illustrating an operating manner of the active RFID tags in accordance with one embodiment of the present invention.

### DESCRIPTION OF EMBODIMENTS

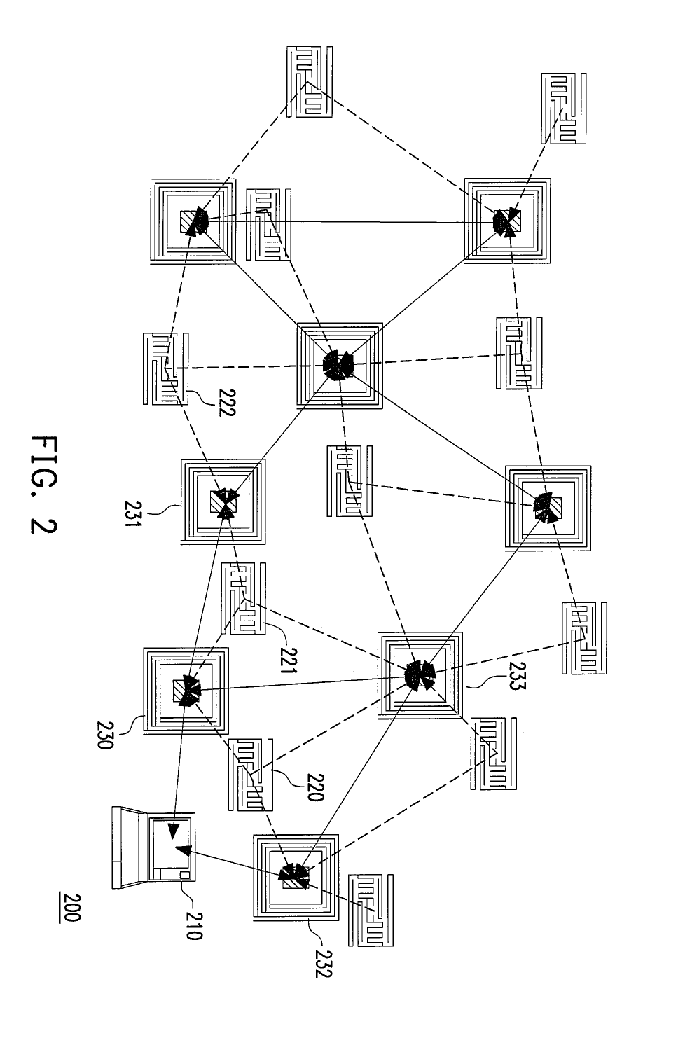

FIG. 2 illustrates a schematic diagram of a radio frequency identification system in accordance with an embodiment of the present invention. Referring to FIG. 2, a wireless radio frequency identification (RFID) system 200 may include at least one sink apparatus 210, at least one passive RFID tag 220, and at least one active RFID tag 230. For the convenience of description, other passive RFID tags and other active RFID tags are further shown in FIG. 2, for example, the passive RFID tags labeled as 221 to 222 and the active RFID tags labeled as 231 to 233.

The RFID system 220 may accomplish a feature of detecting or reading signals mainly via an interaction among the sink apparatus 210, the passive RFID tags (such as the passive RFID tags 220 to 222), and the active RFID tags (such as the active RFID tags 230 to 233) Therefore, for allowing those skilled in this field to apply the spirit of the present invention from the present embodiment, the operation principle of the present embodiment will be described mainly in accordance with the sink apparatus 210, the passive RFID tag 220 and the active RFID tag 230.

Referring to FIG. 2, the active RFID tag 230 may transmit a wireless query signal to detect whether the passive RFID tags 220 to 221 and/or other active RFID tags 231 to 233 are within the scanning range thereof based on a transmission specification. In addition, the active RFID tag 230 may further collect the detecting result into an inventory data. Similarly, other active RFID tags 231 to 233 may also respectively transmit a wireless query signal based on the same transmission specification to accomplish an aspect of reading the identification data in the passive RFID tag (ex. Tags 220, 221 and 222) and/or the inventory data in the active RFID tag.

Moreover, the sink apparatus 210 may transmit another wireless query signal based on the same transmission specification. Thus, the sink apparatus 210 may detect whether the passive RFID tags and/or the active RFID tags are within the scanning range thereof to read the identification data in the passive RFID tag 220 and/or the inventory data in the active RFID tags 230 and 232. In the other words, by utilizing only one transmission specification, the RFID system 200 can accomplish the aspect of detecting and reading the identification data in the passive RFID tag 220 and/or the inventory data in the active RFID tag 230.

It should be noted that the above-mentioned transmission specification may include a transmission specification of class 1 generation 2 set by electronic product code, EPC. However, those skilled in this field should understand that with enhancement on transmission technologies, every country keep re-setting and modifying existing transmission specifications. Therefore, designers can freely change the transmission specification of the RFID system 200 based on the requirements of design. In addition, the RFID system 200 in the present embodiment is integrated together with an ad-hoc networking technology. Thus, besides the advantages of ad-hoc network, the RFID system 200 contains the concepts of transmitting signals of the ad-hoc network.

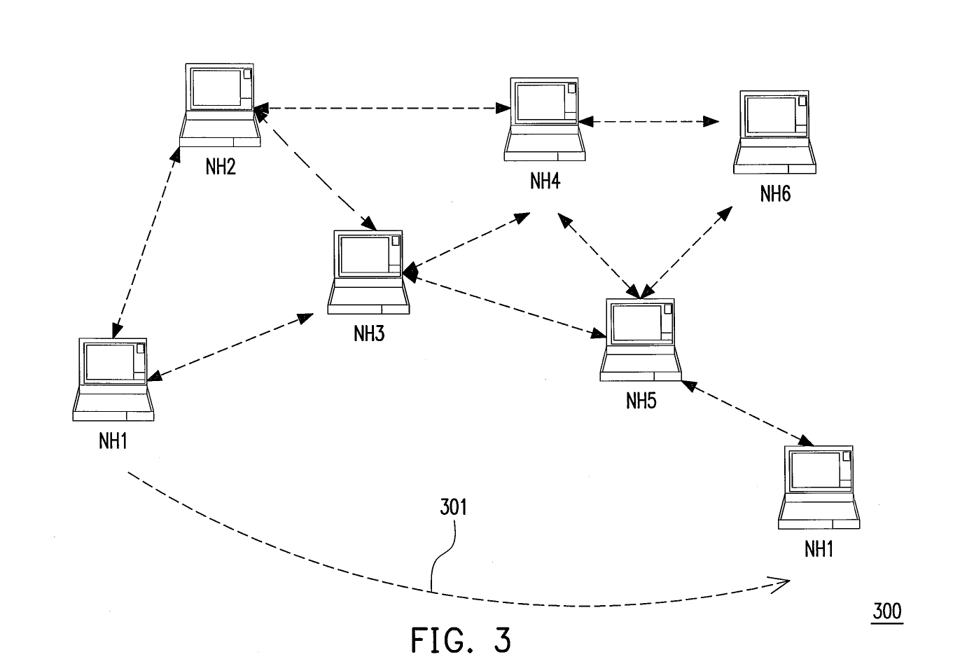

For example, FIG. 3 illustrates a schematic diagram for describing the embodiment of FIG. 2, wherein the ad-hoc network 300 can be consisted of a group of transmission devices MH1 to MH6 which can be randomly moved. Here, a new type of topology of the ad-hoc network can be established based on the movement of the transmission devices MH1 to MH6. For example, as shown in FIG. 3, when a transmission device MH1 is moved in the direction as the arrow 301, the connection between the transmission devices MH2 and MH3 may be interrupted, but meanwhile a new connection to the transmission device MH5 may be established from the transmission device MH1. Moreover, the type of topology of the ad-hoc network may be changed as the devices MH1 to MH6 are increased or reduced. The route for transferring data is selected via a route table by the transmission the devices MH1 to MH6 in the ad-hoc network 300 in corresponding to changeable types of topology. Hence, the ad-hoc network 300 will neither require any fixed base stations or network equipments nor be restricted by the terrain characteristics and the cost of wiring configuration at all.

The present embodiment integrates the active RFID tags in the RFID system 200 with the ad-hoc networking technology. In the other words, the active RFID tags in the RFID system 200 may be equivalent to the transmission devices in the ad-hoc network 300. Therefore, each active RFID tag in the RFID system 200 may determine a route for sending the inventory data via a route table. In addition, the RFID system 300 may have such advantages as listing below after being integrated with the ad-hoc networking technology:

A better fault tolerant capability: since the ad-hoc networking technology has put it into consideration what mobile recovery route for the transmission device can be proceeded while the type of topology has been changed. Thus, as for RFID system 200, no matter what obstacle of route may be caused by the movement of the active RFID tag, the active RFID tag still can find a new route to complete the inventorying of data so that the RFID system 200 may essentially have certain degree of fault tolerant capability after being integrated with the ad-hoc networking technology.

Easy to maintained: comparing with the traditional wired networking technologies or LAN networking technologies requiring access points of wireless network, the active RFID tags integrated with the Ad-ho networking technology is much easier than the traditional manner in many ways such as arrangement, movement of equipment location and obstacle detection or equipment maintenance, and therefore the cost of maintenance thereof is relatively low.

Lower cost: since the message containing range of network gates can be extended through a multi-hop forwarding technology among the active RFID tags, it is not necessary to establish extra access points so that the cost of wiring configuration for wired network can be reduced.

With understanding that the active RFID tag in the present embodiment is integrated mutually with the ad-hoc networking technology, the manner how the active RFID tag delivers the inventory data will be further described hereinafter. Here, when an inventory data is collected by an active RFID tag 230, the transmitting mode for the active RFID tag 230 may be changed from an active-RFID-tag transmitting mode into a passive-RFID-tag transmitting mode (ex. Tags 220, 221 and 222) so that the inventory data collected thereby may be sent out. In other words, the current active RFID tag 230 may be changed into a passive RFID tag, and the inventory data collected thereby may be transferred to other active RFID tags 231 to 233 using the same transmitting manner.

For example, referring to FIG. 2, the active RFID tag 230 can accomplish an aspect of delivering the inventory data collected thereby via two types of manners for transmitting, real-time response and non-realtime response. To shorten the delay of data route, the active RFID tag in FIG. 2 can utilize a manner for real-time response.

After collecting inventory data in a specified number or in a specified period of time, the collected inventory data is immediately delivered to a next active RFID tag based on a route table, alternatively, the collected inventory data is sent out after a wireless query signal delivered from another active RFID tag is received thereby.

It should be noted that a problem of collision may be raised additionally if a transmitting manner for real-time response is adopted by the active RFID tag. Thus, as considering a scenario of a collision may be raised, the active RFID tag in FIG. 2 can also adopt a transmitting manner for non-realtime response to omit the possibility of raising a collision. For the purpose that those skilled in this field can follow the teaching of the present embodiment to accomplish the technical features of the present invention, there will be a more detailed description made for the transmitting manner for real-time response and non-realtime response.

It is assumed that a transmitting manner for real-time response is adopted by the active RFID tags 231 and 233. When both the active RFID tags 231 and 233 respectively transmit an inventory data in each to an active RFID tag 230 and cause a collision occurred, the transmitting manner for real-time response may be interrupted by the aforementioned active RFID tags 231 and 233, and then temporarily a transmitting manner for non-realtime response may be adopted thereby. With re-selecting a time point for transmitting an inventory data, the transmitting manner for non-realtime response can reduce the impact from the collision on a data route. For example, if the transmission specification of the wireless RFID system 200 is class 1 generation 2 set by EPC standard, the current active RFID tag in FIG. 2 may determine a time point for sending the inventory data respectively according to a route information, and the route information in the active RFID tags is corresponding to a Q value set in the transmission specification of class 1 generation 2. In other words, the active RFID tag in FIG. 2 may randomly determine an inventory time respectively based on a value in the route information (Q value) and start to send the inventory information out while the inventory time is final counted down to 0.

However, at a specified time point, when the inventory data is respectively transmitted from each of the active RFID tags 231 and 233 to the active RFID tag 230, which causes a collision occurred, the active RFID tags 231 and 233 may determine if a time point for transmitting respective inventory data should be re-selected based on how serious the occurred collision is so as to avoid raising a collision. For example, when a collision formed in the active RFID tags 231 and 233 has been occurred for three times, the active RFID tags 231 and 233 may randomly re-select a new inventory time respectively based on the value in the route information (Q value). Additionally, a transmitting manner for non-realtime response can not only reduce the possibility of raising collisions but also increase the speed of a data route via an extra transmission mechanism. For example, if a transmission specification of the RFID system 200 is class 1 generation 2 set by EPC standard, then when a passive RFID tag 220 is detected by the active RFID tag 230 via the wireless query signal sent from thereby, the passive RFID tag 220 may determine to be inventoried based on a wireless query signal received thereby and further determine the time point for inventorying based on an access information (corresponding to a Q value set in the transmission specification of class 1 generation 2) in the wireless query signal received thereby. In other words, if the value in the inventory information (Q value) received by the passive RFID tag 220 is 10, the passive RFID tag 220 can randomly select a time point as the time point to be inventoried form a time range from 0 to 21-1.

As for the active RFID tag 230, its time point for sending inventory data is determined via the route information (Q value). It should be noted that the route information (Q value) in the active RFID tag 230 has higher access priority than the route information (Q value) in the passive RFID tag 220. For example, the Q value in the active RFID tag 230 is smaller than the Q value in the passive RFID tag 220. Thus, when the access information (Q value) in the passive RFID tag 220 is 10, that is, the access information (Q value) in the wireless query signal sent by the active RFID tag 230 is 10, the value (Q value) in the route information corresponding to the active RFID tag 230 will be lesser than 10, for example, 2. Hence, the time period of the data route in the RFID system 200 can be effectively reduced.

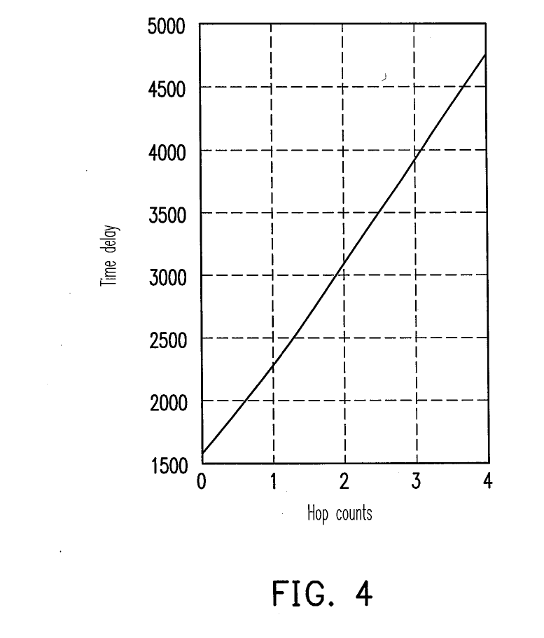

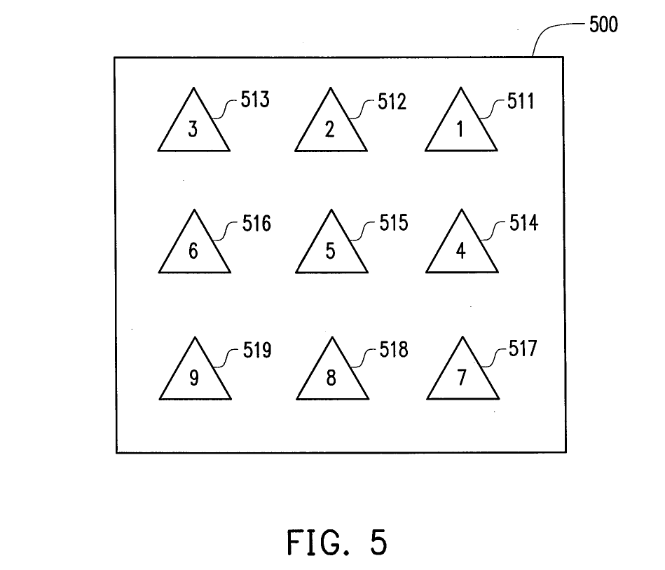

In addition, to verify the feasibility of the present embodiment, FIG. 4 illustrates a simulated chart described in accordance with an embodiment of the present invention, and FIG. 5 is a schematic diagram for illustrating the simulated platform of the embodiment shown in FIG. 4, wherein the configuring conditions of the simulated platform shown in FIG. 5 are shown as following:

A simulated platform includes active RFID tags 511 to 519, and the locations of the active RFID tags 511 to 519 may be respectively located on nine fixed locations.

The passive RFID tags contained in the simulated platform 500 may be uniformly distributed in the simulated platform 500, which are not shown here due to a great number of the passive RFID tags.

The identification data returned by each passive RFID tag is a probability variable in a Poission distribution.

The data accessed between the active RFID tags 511 to 519 and the passive RFID tags is based on a transmission specification of global class 1 generation 2 set by EPC standard.

The data routing path is assumed as a given predetermined path.

The data accessed between the active RFID tags 511 to 519 is similarly based on a transmission specification of global class 1 generation 2 set by EPC standard.

The time period of accessing data and collision is configured according to the connecting time of class 1 generation 2.

Here, FIG. 4 is a simulated chart of hop counts of the active RFID tags and time delay, and the simulating conditions may be verified according to the simulated platform as shown in FIG. 5. With reference to FIG. 4, it can be obviously shown that the delay time almost goes linearly up as the hop counts are increased. Thus, as shown in FIG. 4, it can be verified that the time of transmitting signal may become longer as the route of a transmitting signal gets longer, through which can further verify the feasibility of the radio frequency identification system 200.

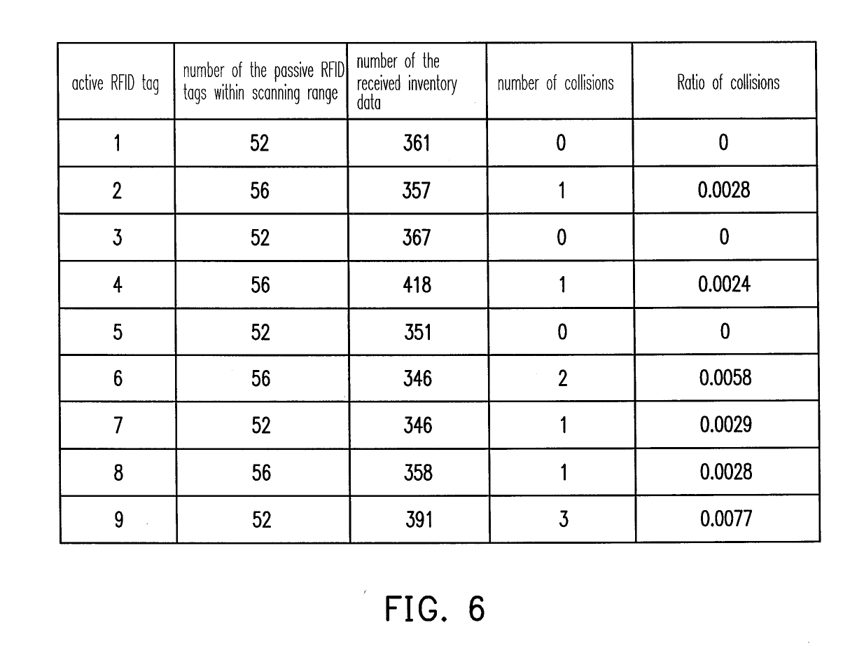

Meanwhile, via the simulated platform, the relationship of data accessing between the active RFID tags 511 to 519 and the passive RFID tags, as well as the relationship of accessing data among the active RFID tags 511 to 519 can be also verified. For example, FIG. 6 illustrates a table of simulation result for explaining an embodiment of the present invention, as shown in FIG. 6, it can be obviously shown what number of the passive RFID tags which can be detected respectively within each scanning range of the active RFID tags 511 to 519 may be. And in the process of scanning, the number of collisions occurred respectively from the active RFID tags 511 to 519 can be also verified in FIG. 6.

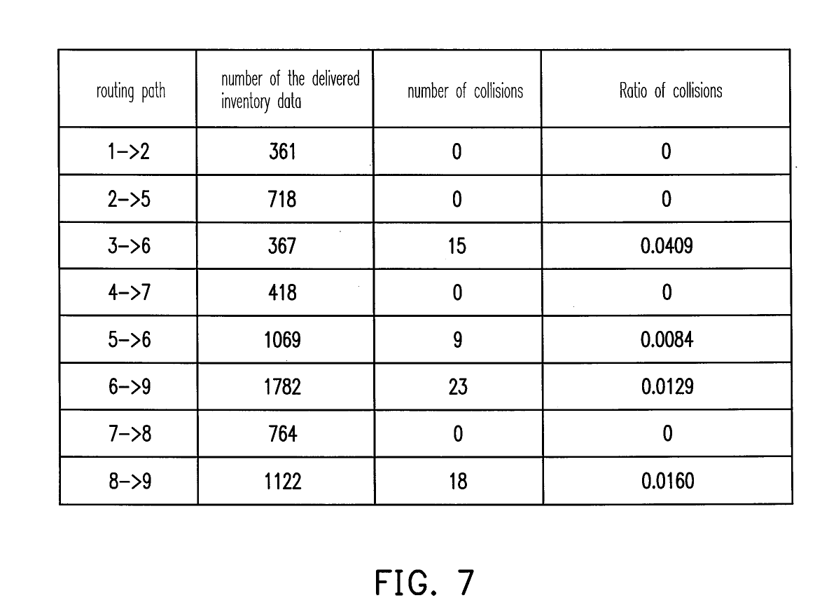

Moreover, FIG. 7 illustrates another table of simulation result for explaining an embodiment of the present invention. A specified routing path among the active RFID tags 511 to 519 can be obtained from FIG. 7. And via the specified routing path, both the number of delivered inventory data for and the number of collisions that may be occurred while the active RFID tags 511 to 519 proceed the data route can be verified via FIG. 7.

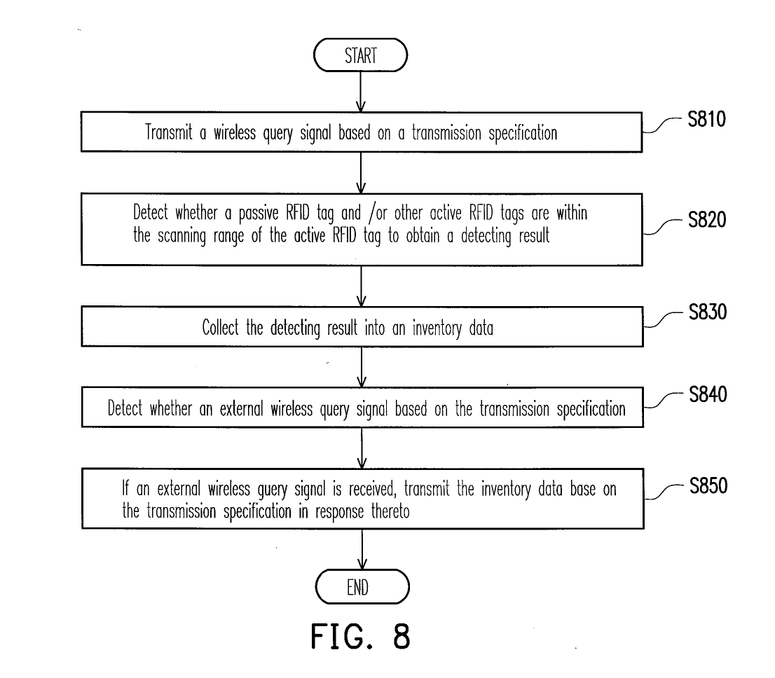

From another point of view, FIG. 8 illustrates a flow chart illustrating an operating manner for the active RFID tags in accordance with an embodiment of the present invention. Please both refer to FIG. 8 and FIG. 2, as well as refer to the operating manner illustrated in FIG. 8 corresponding to the active RFID tags in FIG. 2. In step S810, an active RFID tag 230 can transmit a wireless query signal based on a transmission specification. Then, in step S820, it my be detected whether a passive RFID tag 220 and/or other active RFID tags 231 to 233 are within the scanning range of the active RFID tag 230 to obtain a detecting result. And in step S 830, the detecting result may be collected into an inventory data.

Hence, in steps S840 and S850, an external query signal may be detected by the active RFID tag 230 based on the above-mentioned transmission specification. In addition, if an external wireless query signal is received, the active RFID tag 230 may transmit the inventory data corresponding thereto based on the above-mentioned transmission specification in response to the external wireless query signal received thereby. For example, both the wireless query signal transmitted by the active RFID tags 231 to 233 or another wireless query signal transmitted by a sink apparatus 210 can form the aforementioned wireless query signal. Therefore, the active RFID tag 230 can transfer the inventory data collected thereby to the active RFID tags 231 to 233 or the sink apparatus 210 via the external wireless query signal received thereby. As for the other details in this operating manner, which has been included in the embodiment of FIG. 2, will not be further described hereinafter.

In summary, the present invention adopts active RFID tags of only one transmission specification to accomplish the features of detecting and reading the identification data in passive RFID tags and/or the inventory data in the active RFID tags so as to a RFID system applying such active RFID tags may provide advantages shown as following while comparing with the traditional RFID system:

Under the consideration of time, the present invention adopts a single transmission specification, for example, the class-1 generation-2 set by EPC standard, so that time spent on converting internet stacks can be effectively saved.

Under the consideration of power, since the RFID system of the present invention does not need to consume extra power in converting stacks, the consumption on power of the system can be effectively reduced.

Under the consideration of cost, since the hardware devices of the active RFID tags in the present invention only support a single transmission specification, the cost of the system is effectively saved while the complexity of circuits is reduced.

Under the consideration of compatibility, the present invention adopts a single transmission specification, which thus results in having higher compatibility.

Although the present invention has been disclosed above by the embodiments, they are not intended to limit the present invention. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless radio frequency identification (RFID) system, comprising:
at least one passive RFID tag;
at least one active RFID tag, which transmits a wireless query signal based on a transmission specification to detect whether the passive RFID tag and/or other active RFID tag are within a scanning range thereof and collects the result into an inventory data; and
at least one sink apparatus, which transmits another wireless query signal based on the same said transmission specification to detect whether the passive RFID tag and/or the active RFID tag are within the scanning range thereof to read the identification data in the passive RFID tag and/or the inventory data in the active RFID tag accordingly.

2. The wireless RFID system as claimed in claim 1, further comprising:
a plurality of active RFID tags, which transmit a second wireless query signal based on the said transmission specification to detect whether the passive RFID tags and/or other active RFID tags are within the scanning range thereof and collects the detecting result into a second inventory data;
wherein the second active RFID tags respectively re-select a time point for transmitting respective second inventory data when the said second active RFID tags transmit respective second inventory data to the said active RFID tag simultaneously.

3. The wireless RFID system as claimed in claim 1, wherein the said active RFID tag determines a time point for sending the inventory data based on a route information; and the passive RFID tag determines a time point for returning the identification data corresponding thereto based on an access information in the aforementioned wireless query signal, wherein the route information has a higher access priority than the access information.

4. The wireless RFID system as claimed in claim 1, wherein the said transmission specification includes an electronic product code (EPC) standard.

5. The wireless RFID system as claimed in claim 1, wherein a transmitting mode for the said active RFID tag is converted from an active-RFID-tag transmitting mode to a passive-RFID-tag transmitting mode to transmit the inventory data to other active RFID tags while the inventory data is collected by the active RFID tag.

6. A method for operating an active radio frequency identification (RFID) tag, comprising:
transmitting a wireless query signal based on a transmission specification;
detecting whether a passive RFID tag and/or other active RFID tags are within a scanning range of the active RFID tag to obtain a detecting result;
collecting the detecting result into an inventory data;
detecting whether an external wireless query signal is provided based on the transmission specification; and
transmitting the inventory data in response to the external wireless query signal based on the transmission specification if the external wireless query signal is received.

7. The method for operating the active RFID tag as claimed in claim 6, further comprising:
reselecting a time point for a plurality of the said other active RFID tags respectively to transmit the inventory data in response thereto when other active RFID tags transmit respective inventory data thereof to the active RFID tag simultaneously.

8. The method for operating the active RFID tag as claimed in claim 6, further comprising:
determining a time point for sending the inventory data based on a route information
determining a time point for returning the identification data in a passive RFID tag based on an access information in the wireless query signal,
wherein the said route information has a higher access priority than the access information.

9. The operating method for active RFID tag as claimed in claim 6, wherein the said transmission specification includes an electronic product code (EPC) standard.

10. The method for operating the active RFID tag as claimed in claim 6, wherein a transmitting mode for the said active RFID tag is converted from an active-RFID-tag transmitting mode to a passive-RFID-tag transmitting mode to transmit the inventory data to other active RFID tags when the inventory data is collected by the active RFID tag.
